(19) United States
(12) Patent Application Publication
(10) Pub. No.: US 2021/0175570 A1
(43) Pub. Date: Jun. 10, 2021

(54) BATTERY COVER

(71) Applicant: NITTO DENKO CORPORATION, Osaka (JP)

(72) Inventors: Masashi NISHINO, Osaka (JP); Takashi KOIZUMI, Osaka (JP); Kazumasa TAKAKURA, Osaka (JP)

(73) Assignee: NITTO DENKO CORPORATION, Osaka (JP)

(21) Appl. No.: 16/761,360

(22) PCT Filed: Nov. 14, 2018
(86) PCT No.: PCT/JP2018/042111

§ 371 Date: May 4, 2020

(30) Foreign Application Priority Data
Nov. 17, 2017 (JP) 2017-222190

(51) Int. Cl. H01M 50/202; H01M 50/231; H01M 50/227; H01M 50/249; H01M 50/233

(52) U.S. Cl. CPC H01M 50/202; H01M 50/231; H01M 2220/20; H01M 50/249; H01M 50/233; H01M 50/227

(57) ABSTRACT

A battery cover includes a side wall surrounding a battery, and the side wall includes a porous layer, and a protective layer disposed at one side and the other side in a thickness direction of the porous layer. The thermal conductivity of the porous layer is 0.033 W/(m·K) or less.

### CROSS-REFERENCE TO RELATED APPLICATIONS

The present application is a 35 U.S.C. 371 National Stage Entry of PCT/JP2018/042111, filed on Nov. 14, 2018, which claims priority from Japanese Patent Application No. 2017-222190, filed on Nov. 17, 2017, the contents of all of which are herein incorporated by reference in their entirety.

### TECHNICAL FIELD

The present invention relates to a battery cover, to be specific, to a battery cover that is used so as to protect a battery used for a vehicle from heat.

### BACKGROUND ART

Generally, a battery for a vehicle is set at the inside of an engine room. In the battery for a vehicle, the surface of the battery is heated by heat from an engine or the like, and a battery liquid at the inside of the battery is increased to a high temperature. As a result, a battery life is reduced.

To protect the battery from the heat, a battery cover that covers the side surfaces of the battery has been proposed (ref: for example, Patent Document 1). Patent Document 1 discloses the battery cover including a wall material made of a polyurethane resin foam that covers the side surfaces of the battery.

### CITATION LIST

### Patent Document

Patent Document 1: Japanese Unexamined Patent Publication No. 2016-84836

### SUMMARY OF THE INVENTION

### Problem to be Solved by the Invention

The battery cover described in Patent Document 1 has good heat insulating properties, and the heat insulating properties required for the battery cover has been recently furthermore increased.

The present invention provides a battery cover having excellent heat insulating properties.

### Means for Solving the Problem

The present invention [1] includes a battery cover including a side wall surrounding a battery, wherein the side wall includes a porous layer, and a protective layer disposed at one side and the other side in a thickness direction of the porous layer, and the thermal conductivity of the porous layer is 0.033 W/(m·K) or less.

The present invention [2] includes the battery cover described in [1], wherein the protective layer has a napping portion disposed to face to the battery and the napping portion has a thickness of 400 μm or more.

The present invention [3] includes the battery cover described in [1] or [2], wherein the porous layer is a phenol resin foam or a silica aerogel-containing non-woven fabric.

The present invention [4] includes the battery cover described in any one of [1] to [3], wherein the porous layer has a thickness of 15.0 mm or less.

### Effect of the Invention

The battery cover of the present invention includes the porous layer having the thermal conductivity of 0.033 W/(m·K) or less, and the protective layer disposed at both sides of the porous layer. Thus, the battery cover of the present invention has excellent heat insulating properties compared to the conventional battery cover.

### BRIEF DESCRIPTION OF THE DRAWINGS

FIG. 1 shows a perspective view of a one embodiment of a battery cover of the present invention.

FIG. 2 shows a side cross-sectional view of the battery cover shown in FIG. 1.

FIG. 3 shows an enlarged view in a napping portion of the side cross-sectional view of the battery cover shown in FIG. 2.

FIG. 4 shows a perspective view in a state in which the battery cover shown in FIG. 1 is mounted on a battery.

FIG. 5 shows a side view of a state of a heat insulating properties test in Examples.

FIG. 6 shows a reference view of a histogram used at the time of measurement of a thickness of a napping portion.

### DESCRIPTION OF EMBODIMENTS

### One Embodiment

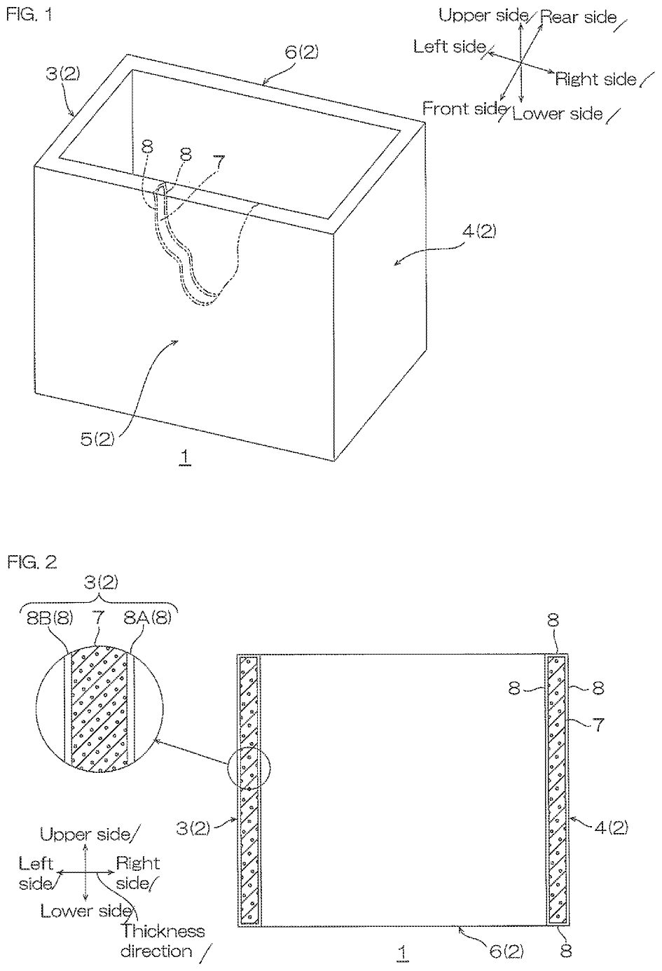

A battery cover 1 of a one embodiment of the present invention is described with reference to FIGs. in the following. In FIG. 2, the up-down direction on the plane of the sheet is an up-down direction (first direction), the upper side on the plane of the sheet is an upper side (one side in the first direction), and lower side on the plane of the sheet is a lower side (the other side in the first direction). In FIG. 2, the right-left direction on the plane of the sheet is a right-left direction (second direction perpendicular to the first direction), the left side on the plane of the sheet is a left side (one side in the second direction), and the right side on the plane of the sheet is a right side (the other side in the second direction). In FIG. 2, the paper thickness direction on the plane of the sheet is a front-rear direction (third direction perpendicular to the first direction and the second direction), the near side on the plane of the sheet is a front side (one side in the third direction), and the far side on the plane of the sheet is a rear side (the other side in the third direction). To be specific, directions are in conformity with direction arrows described in each view.

As referred to FIG. 1, the battery cover 1 has a rectangular pipe shape extending in the up-down direction, and has a generally rectangular frame shape in planar view. The battery cover 1 includes a plurality of (four) side walls 2.

The four side walls 2 include a first wall 3 and a second wall 4 that are disposed in opposed relation at spaced intervals to each other in the right-left direction, and a third wall 5 and a fourth wall 6 that are disposed in opposed relation at spaced intervals to each other in the front-rear direction.

The first wall 3 has a generally rectangular flat plate shape when viewed from the side in the right-left direction. To be specific, the first wall 3 has a generally rectangular shape (rectangle-shaped) in which a length in the up-down direction is longer than that in the front-rear direction. The front end portion of the first wall 3 is connected to the left end portion of the third wall 5, and the rear end portion of the first wall 3 is connected to the left end portion of the fourth wall 6.

The second wall 4 has generally the same shape as that of the first wall 3. That is, the second wall 4 has a generally rectangular flat plate shape when viewed from the side in the right-left direction. To be specific, the second wall 4 has a generally rectangular shape (rectangle-shaped) in which the length in the up-down direction is longer than that in the front-rear direction. The front end portion of the second wall 4 is connected to the right end portion of the third wall 5, and the rear end portion of the second wall 4 is connected to the right end portion of the fourth wall 6.

The third wall 5 has a generally rectangular flat plate shape when viewed from the side when visually recognized in the front-rear direction. To be specific, the third wall 5 has a generally rectangular shape (rectangle-shaped) in which the length in the right-left direction is longer than that in the up-down direction. The left end portion of the third wall 5 is connected to the front end portion of the first wall 3, and the right end portion of the third wall 5 is connected to the front end portion of the second wall 4.

The fourth wall 6 has generally the same shape as that of the third wall 5. That is, the fourth wall 6 has a generally rectangular flat plate shape when viewed from the side when visually recognized in the front-rear direction. To be specific, the fourth wall 6 has a generally rectangular shape (rectangle-shaped) in which the length in the right-left direction is longer than that in the up-down direction. The left end portion of the fourth wall 6 is connected to the rear end portion of the first wall 3, and the right end portion of the fourth wall 6 is connected to the rear end portion of the second wall 4.

The side walls 2 (the first wall 3, the second wall 4, the third wall 5, and the fourth wall 6) are made of the same structure and the same material. As shown by a phantom line of FIG. 1, and FIG. 2, each of the side walls 2 includes a porous layer 7, and protective layers 8 that are laminated on both surfaces in the thickness direction (one-side surface and the other-side surface in the thickness direction) of the porous layer 7. That is, the first wall 3, the second wall 4, the third wall 5, and the fourth wall 6 sequentially include the protective layer 8, the porous layer 7, and the protective layer 8 in the thickness direction (direction perpendicular to a plane direction in a flat plate shape; that is, in FIG. 1, the right-left direction in the first wall 3 and the second wall 4, and the front-rear direction in the third wall 5 and the fourth wall 6).

The protective layer 8 is disposed on the upper surface (one-side surface in the direction perpendicular to the thickness direction) and the lower surface (the other-side surface in the direction perpendicular to the thickness direction). That is, the upper surface and the lower surface of the porous layer 7 are covered with the protective layer 8.

The thermal conductivity of the porous layer 7 is 0.033 W/(m·K) or less, preferably 0.030 W/(m·K) or less, more preferably 0.025 W/(m·K) or less, and for example, 0.001 W/(m·K) or more. The thermal conductivity can be measured by, for example, a hot wire probe method in conformity with JIS R2616 or ASTM D5930. To be specific, a quick thermal conducting meter (manufactured by KYOTO ELECTRONICS MANUFACTURING CO., LTD., trade name: “QTM-500”) at room temperature is used.

The density of the porous layer 7 is, for example, 100 kg/m³ or less, preferably 50 kg/m³ or less, and for example, 1 kg/m³ or more, preferably 10 kg/m³ or more. The density can be measured in conformity with JIS A9521 or JIS K6767. By setting the density at the above-described upper limit or less, the thermal conductivity can be more surely reduced.

Examples of a material for the porous layer 7 include foams such as phenol resin foam and polyethylene resin foam and non-foams such as silica aerogel-containing non-woven fabric. In view of a more reliable reduction in the thermal conductivity, preferably, a phenol resin foam and a silica aerogel-containing non-woven fabric are used, more preferably, a phenol resin foam is used.

The phenol resin foam (phenol foam) is a product obtained by allowing a phenol resin to foam. To be specific, an example thereof includes NEOMAFOAM (trade name) manufactured by Asahi Kasei Corporation.

The polyethylene resin foam (polyethylene foam) is a product obtained by allowing a polyethylene resin to foam. To be specific, an example thereof includes TORAYPEF (trade name) manufactured by TORAY INDUSTRIES, INC.

When the porous layer 7 is the foam (foaming layer), an existence ratio (number) of a closed cell thereof with respect to the total cell is, for example, 50% or more, preferably 80% or more, and for example, 100% or less.

An average cell size is, for example, below 100 μm, and for example, 10 μm or more. The average cell size can be, for example, calculated by measuring the maximum size of each of the cell by enlarging a cross-sectional view of the porous layer 7 with a microscope.

The silica aerogel-containing non-woven fabric includes a non-woven fabric and a silica aerogel (gel) that is contained at the inside of the non-woven fabric. The silica aerogel is a porous material obtained by replacing a solvent contained in a gelatinous silica with a gas. An example of the non-woven fabric includes a non-woven fabric to be described later in the protective layer 8. To be specific, an example of the silica aerogel-containing non-woven fabric includes Thermal Wrap (trade name) manufactured by Cabot Corporation.

The porous layer 7 has a thickness (in the case of the first wall 3 and the second wall 4, a length in the right-left direction, and in the case of the third wall 5 and the fourth wall 6, a length in the front-rear direction) of, for example, 20.0 mm or less, preferably 15.0 mm or less, more preferably 12.0 mm or less, further more preferably 10.0 mm or less, and for example, 2.0 mm or more, preferably 5.0 mm or more. By setting the thickness of the porous layer 7 at the above-described upper limit or less, a reduction in size of the battery cover 1 can be achieved. By setting the thickness of the porous layer 7 at the above-described lower limit or more, the heat insulating properties of the battery cover 1 can be more surely improved.

The thickness of the porous layer 7 can be, for example, measured by using a caliper.

The protective layer 8 is a layer that suppresses damage and lack of the porous layer 7 caused by impact from the outside, chemicals, or the like, and also a layer that improves the heat insulating properties of the entire battery cover 1 by assisting the heat insulating properties of the porous layer 7.

The protective layer 8 includes an inner-side protective layer 8A that is disposed at the side of a battery 10 with respect to the porous layer 7, and an outer-side protective layer 8B that is disposed at the opposite side to the battery 10 with respect to the porous layer 7. That is, the inner-side protective layer 8A is in contact with the inner-side surface of the porous layer 7, the outer-side protective layer 8B is in contact with the outer-side surface of the porous layer 7, and the porous layer 7 is disposed between the inner-side protective layer 8A and the outer-side protective layer 8B.

Examples of the protective layer 8 include plastic film (including a plastic sheet), woven fabric, and non-woven fabric (including a felt).

Examples of a material for the protective layer 8 include thermoplastic resins such as polyester resin, polyolefin resin, polyurethane resin, polycarbonate resin, polyvinyl chloride, and styrene butadiene rubber (SBS).

As the protective layer 8, preferably, a non-woven fabric is used, more preferably, a resin-impregnated non-woven fabric and a plastic film-laminated non-woven fabric are used, further more preferably, a plastic film-laminated non-woven fabric is used. The resin-impregnated non-woven fabric includes a non-woven fabric and a resin that is impregnated in the non-woven fabric. The plastic film-laminated non-woven fabric is a non-woven fabric that is lined with a plastic film, and includes a non-woven fabric and a plastic film that is laminated on the surface in the thickness direction of the non-woven fabric.

The non-woven fabric is, for example, formed from fibers such as natural fibers such as cotton, wool, hemp, pulp, silk, and mineral fiber; chemical fibers such as polyester fiber (for example, polyethylene terephthalate or the like), rayon, nylon fiber, vinylon fiber, acrylic fiber, aramid fiber, and polypropylene fiber; and glass fibers. Of these, in view of heat resistance, chemical resistance, handleability, or the like, preferably, a chemical fiber is used, more preferably, a polyester fiber is used.

Examples of a producing method of the non-woven fabric include dry method, wet method, spunbond method, thermal bond method, chemical bond method, stitch bond method, needle punch method, melt blow method, spun lace method, and steam jet method.

A basis weight of the non-woven fabric is, for example, 5 g/m² or more, preferably 50 g/m² or more, and for example, 1200 g/m² or less, preferably 500 g/m² or less, more preferably 200 g/m² or less.

As the resin contained in the resin-impregnated non-woven fabric, any one of a thermosetting resin and a thermoplastic resin (to be specific, the above-described thermoplastic resin) may be used, preferably, a thermosetting resin is used.

Examples of the thermosetting resin include phenol resin and resorcin resin (resorcinol resin). In view of heat resistance, chemical resistance, or the like, preferably, a resorcin resin is used.

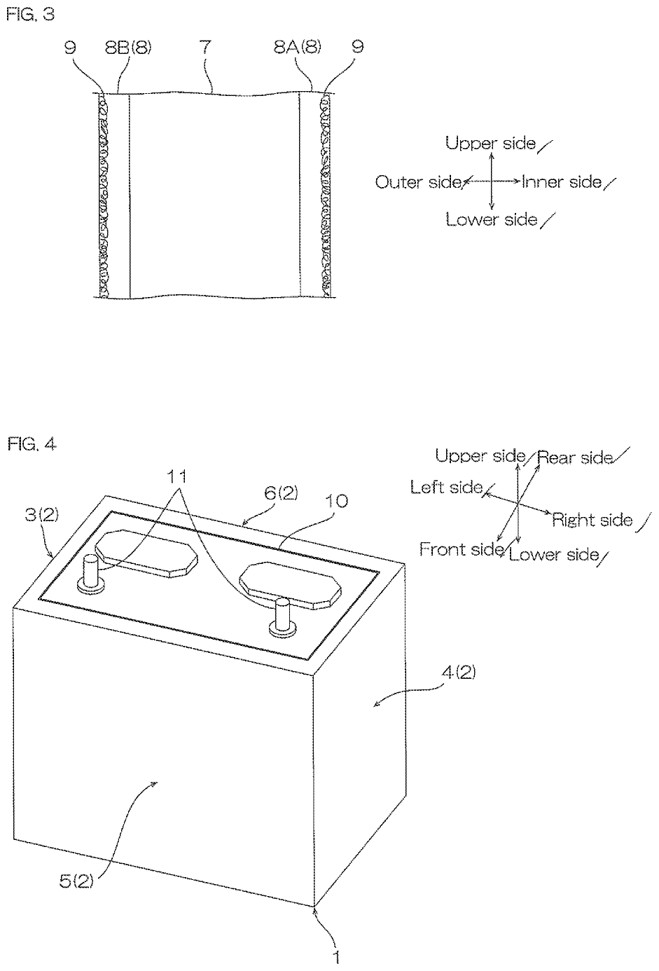

As shown in FIG. 3, the protective layer 8 includes a napping portion 9 on the surface in the thickness direction (the surface at the opposite side to the surface in contact with the porous layer 7). To be specific, the napping portion 9 is disposed on the surface (inner-side surface) at the side of the battery of the inner-side protective layer 8A, and on the surface (outer-side surface) at the opposite side to the battery of the outer-side protective layer 8B.

The napping portion 9 is a portion in which the fibers constituting the surface of the protective layer 8 are napped and having a fluffy feeing.

The napping portion 9 has a thickness (height) of, for example, 50 μm or more, preferably 400 μm or more, more preferably 500 μm or more, and for example, 2000 μm or less, preferably 1000 μm or less, more preferably 600 μm or less. To be more specific, the napping portion 9 has the above-described thickness in a ratio of 80% or more (preferably, 90% or more, more preferably 100%) of the surface in the thickness direction of the protective layer 8 (the surface area of the protective layer 8 when visually recognized in the thickness direction). By setting the thickness of the napping portion 9 at the above-described lower limit or more, a temperature difference between the one-side surface and the other-side surface in the thickness direction of the side wall 2 can be further improved, and the heat insulating properties can be furthermore excellent.

The thickness of the napping portion 9 can be calculated by, for example, measuring a height of unevenness on the surface of the protective layer 8 by using a laser microscope to calculate a difference between the maximum height (Hmax) of the unevenness and an average height (Havg) of the unevenness. The details are described later in Examples.

To be specific, examples of the protective layer 8 include resorcin resin-impregnated polyester non-woven fabric such as “NE8-80EU” manufactured by Nagoya Oilchemical Co., Ltd.; polyolefin film such as “No. 2100” manufactured by NITTO DENKO CORPORATION; polyvinyl chloride film such as “No. 2100FRTV” manufactured by NITTO DENKO CORPORATION; polyurethane film such as “SILKLON” manufactured by Okura Industrial Co., Ltd.; polypropylene sheet such as “DANPLATE” manufactured by UBE EXSYMO CO., LTD.; polyester/rayon composite non-woven fabric such as “ZETAFELT” manufactured by HOF; and polypropylene film-laminated polyethylene terephthalate non-woven fabric manufactured by Maeda Kosen Co., Ltd.

The protective layer 8 has a thickness of, for example, 0.01 mm or more, preferably 0.1 mm or more, and for example, 10.0 mm or less, preferably 5.0 mm or less. The thickness of the protective layer 8 can be measured by, for example, using the caliper.

The basis weight of the protective layer 8 is, for example, 10 g/m² or more, preferably 50 g/m² or more, and for example, 1200 g/m² or less, preferably 500 g/m² or less, more preferably 200 g/m² or less.

The side wall 2 has a thickness of, for example, 5.0 mm or more, preferably 8.0 mm or more, and for example, 20.0 mm or less, preferably 15.0 mm or less. The thickness of the side wall 2 can be measured by, for example, using the caliper.

The two protective layers 8 that are disposed at one side and the other side in the thickness direction of the porous layer 7 may be made of the same material or made of different materials.

For example, the porous layer 7 and the protective layers 8 are prepared, and the protective layers 8 are sequentially disposed on both surfaces in the thickness direction of the porous layer 7 to be subsequently trimmed, so that the battery cover 1 is produced.

To be specific, the porous layer 7 and the two protective layers 8 that are slightly larger than the porous layer 7 are prepared to be laminated so that the protective layers 8 are disposed on both surfaces in the thickness direction of the porous layer 7. Subsequently, the end portions (protruding portions from the porous layer 7) of the two protective layers 8 adhere to each other by heating or the like, so that a wall material (laminate of the porous layer 7 and the protective layer 8) is produced. At this time, the wall material is produced so as to have the outer shape in a development view of the battery cover 1. The wall material is formed so that, for example, the first wall 3, the third wall 5, the second wall 4, and the fourth wall 6 have a continuous shape in a longitudinal direction. Lastly, the end portions of the wall material (for example, the end portion (rear end portion) of the first wall 3 and the end portion (left end portion) of the fourth wall 6) are connected to each other to be trimmed into a rectangular pipe shape.

The battery cover 1 can be used as a heat insulating material that protects a battery such as secondary cell to be mounted on, for example, a vehicle, a ship, or the like from heat from the outside, and preferably used as a heat insulating material that protects a battery to be mounted on an engine portion of a vehicle.

As shown in FIG. 4, the battery cover 1 is used by being mounted on the battery 10. To be specific, the battery 10 is disposed at the inside of the battery cover 1 so that the four side walls 2 surround the entire side surfaces of the battery 10. At this time, the entire four side surfaces of the battery 10 are in contact with the inner-side surfaces of the four side walls 2. That is, the napping portion 9 of the inner-side protective layer 8A of each of the side walls 2 is disposed to face to the battery 10 so as to be in contact therewith. The upper surface (terminal surface) and the lower surface of the battery 10 are exposed from the battery cover 1.

The battery 10 is the secondary cell to be mounted on the vehicle, the ship, or the like, and preferably the secondary cell to be mounted on the vehicle. The battery 10 has a generally rectangular parallelepiped shape, and two terminals 11 are provided on the upper surface thereof.

In this manner, the battery 10 can be protected from the heat by preventing the heat from an engine of the vehicle or the like from direct contact with the side surface of the battery 10.

The battery cover 1 includes the four side walls 2 (the first wall 3, the second wall 4, the third wall 5, and the fourth wall 6) that surround the battery 10, and each of the four side walls 2 includes the porous layer 7, and the protective layers 8 that are disposed on both surfaces in the thickness direction of the porous layer 7. The thermal conductivity of the porous layer 7 is 0.033 W/(m·K) or less. Thus, the heat insulating properties of the battery cover 1 are excellent.

That is, the thermal conductivity of the porous layer 7 is extremely small of 0.033 W/(m·K) or less, so that the heat going from the outside (for example, the engine portion) through the side wall 2 to reach the side surface of the battery 10 can be reduced. The side wall 2 includes the protective layers 8 that are disposed on both surfaces in the thickness direction of the porous layer 7, and two borders (interface between the porous layer and the protective layer) having different materials are present in the thickness direction, so that the heat conduction in the thickness direction in the side wall 2 can be suppressed. In this manner, the battery cover 1 notably has excellent heat insulating properties compared to the conventional battery cover.

The protective layers 8 are disposed on both surfaces in the thickness direction of the porous layer 7, so that the battery cover 1 has excellent various functions such as chemical resistance, water resistance, abrasion resistance, and flame resistance.

The battery cover 1 preferably has the napping portion 9 having a thickness of 400 μm or more on the inner-side surface of the inner-side protective layer 8A that is disposed at the side of the battery 10. Thus, more air can be included in the napping portion 9 that is in contact with the battery 10. Accordingly, the temperature difference between the one-side surface and the other-side surface in the thickness direction of the side wall 2 can be further improved, and the heat insulating properties can be furthermore excellent.

### Modified Example

(1) In the embodiment shown in FIG. 1, each of the side walls 2 (the first wall 3, the third wall 5, the second wall 4, and the fourth wall 6) is made of the porous layer 7 and the protective layer 8. Alternatively, for example, though not shown, each of the side walls 2 can also further include a heat insulating layer.

The heat insulating layer is disposed at the outside of the protective layer 8 that is disposed at the outside (the opposite side to the side at which the battery 10 is disposed) via a pressure-sensitive adhesive layer.

An example of the heat insulating layer includes a corrugated plastic board. The corrugated plastic board is formed from, for example, a polyolefin sheet such as polypropylene sheet. To be specific, the corrugated plastic board is described in Japanese Unexamined Patent Publication No. 2016-11112 or the like.

In the embodiment, the heat insulating properties of the battery cover 1 can be further improved.

(2) In the embodiment shown in FIG. 1, the protective layers 8 are disposed on the upper surface and the lower surface of each of the side walls 2. Alternatively, for example, though not shown, the protective layer 8 may not be disposed on the upper surface and the lower surface of each of the side walls 2, and the upper surface and the lower surface of the porous layer 7 may be also exposed.

In view of suppression of deterioration (for example, a reduction in the heat insulating properties and the mechanical strength) of the porous layer 7 caused by entry of moisture on the upper surface and the lower surface of each of the side walls 2, preferably, the embodiment shown in FIG. 1 is used.

(3) In the embodiment shown in FIG. 1, all of the side walls 2 (the first wall 3, the second wall 4, the third wall 5, and the fourth wall 6) include the porous layer 7 and the protective layer 8. Alternatively, for example, though not shown, only the one side wall 2 can also include the porous layer 7 and the protective layer 8. Of the first wall 3, the third wall 5, the second wall 4, and the fourth wall 6, two or three of these may include the porous layer 7 and the protective layer 8. In view of insulation of the heat from the entire side directions and reliable protection of the battery 10 from the heat, preferably, the embodiment shown in FIG. 1 is used.

(4) In the embodiments shown in FIGS. 1 and 3, each of the protective layers 8 (the inner-side protective layer 8A and the outer-side protective layer 8B) disposed at both sides of the porous layer 7 includes the napping portion 9. Alternatively, for example, though not shown, at least one or both of the inner-side protective layer 8A and the outer-side protective layer 8B may not include the napping portion 9.

In view of exhibiting more excellent heat insulating properties, preferably, at least the inner-side protective layer 8A includes the napping portion 9, more preferably, as shown in FIG. 3, both of the inner-side protective layer 8A and the outer-side protective layer 8B include the napping portion 9.

(5) The shape or the like of the battery cover 1 and the side wall 2 of the embodiment shown in FIG. 1 can be, for example, appropriately changed. As one example, the shape described in Japanese Unexamined Patent Publication No. 2016-84836 or the like is used.

To be specific, the side wall 2 shown in FIG. 1 has a generally rectangular shape when viewed from the side. However, the shape thereof is not limited. Alternatively, for example, though not shown, the side wall 2 can have a shape in which a portion thereof is cut out into a generally U-shape. In this manner, the side surface (for example, a battery liquid detecting portion) of the battery 10 can be visually recognized, while the side surface of the battery 10 is exposed, and the battery cover 1 is kept being mounted on the battery 10. Also, the side wall 2 such as the first wall 3 can have a through hole passing through in the thickness direction.

The side wall 2 can also include one or two or more spacers that are in contact with the side surface of the battery 10 at the inside thereof. For example, the spacer is provided at the inside of the side wall 2 and the entire peripheral upper end portion of the side wall 2. Or, in addition to this, the spacer may be also provided at the inside of the side wall 2 and the entire peripheral lower end portion thereof. Furthermore, the spacer may be also provided at only the entire peripheral lower end portion. In this manner, an air layer can be present between the side wall 2 and the side surface of the battery 10, and the heat insulating properties can be improved.

The side wall 2 can also include a thin portion in which the porous layer 7 is compressed in the thickness direction. The thin portion is formed in the upper end portion and the lower end portion of the side wall 2. In this manner, the strength of the upper end portion and the lower end portion of the side wall 2 is improved, and the entry of impurities such as water from the upper end surface and the lower end surface can be suppressed.

The battery cover 1 can be also formed so that a portion of the inner-side surfaces of the four side walls 2 is in contact with the side surface of the battery 10, and another portion of the inner-side surfaces of the four side walls 2 is disposed at spaced intervals to the side surface of the battery 10.

The battery cover 1 has a generally rectangular frame shape in planar view. That is, the corner portion of the battery cover 1 has a right angle shape in planar view. Alternatively, for example, though not shown, the corner portion of the battery cover 1 can also have a variable structure into an acute angle or an obtuse angle in planar view. In this manner, in the battery cover 1, for example, the inner-side surfaces of the first wall 3 and the third wall 5 are brought into contact with the side surfaces of the fourth wall 6 and the second wall 4, so that a folded structure can be achieved.

The side walls 2 (the first wall 3, the third wall 5, the second wall 4, and the fourth wall 6) are directly connected to each other. Alternatively, for example, though not shown, the side walls 2 can be also indirectly connected to each other via a connecting portion. The battery cover 1 can be also continuous from the upper end edge to the lower end edge of the battery cover 1 in the up-down direction, and can include an opening/closing portion passing through in the thickness direction.

### EXAMPLES

Next, the present invention is further described based on Examples and Comparative Examples shown below. The present invention is however not limited by these Examples and Comparative Examples. The specific numerical values in mixing ratio (content ratio), property value, and parameter used in the following description can be replaced with upper limit values (numerical values defined as “or less” or “below”) or lower limit values (numerical values defined as “or more” or “above”) of corresponding numerical values in mixing ratio (content ratio), property value, and parameter described in the above-described “DESCRIPTION OF EMBODIMENTS”.

### Example 1

As a porous layer, one phenol resin foam (thermal conductivity of 0.024 W/(m·k), density of 34 kg/m³, closed cell ratio of 95%, thickness of 7.0 mm, manufactured by Asahi Kasei Corporation, “NEOMAFOAM A75”), and as a protective layer, two polyester non-woven fabrics impregnated with resorcin (PET fiber-containing, basis weight of 115 g/m², thickness of 1.0 mm, manufactured by Nagoya Oilchemical Co., Ltd., “NE8-80EU”) were prepared. The protective layers were laminated on the one-side surface and the other-side surface in the thickness direction of the porous layer, and the peripheral end portions of the protective layers were subjected to thermocompression bonding. In this manner, a side wall (wall material, thickness of 9.0 mm) in which the protective layers were laminated on both surfaces in the thickness direction of the porous layer was produced.

### Example 2

A side wall was produced in the same manner as that of Example 1, except that a silica aerogel-containing non-woven fabric (thermal conductivity of 0.030 W/(m·k), density of 70 kg/m³, thickness of 8.0 mm, manufactured by Cabot Corporation, “Thermal Wrap TW800”) was used instead of the phenol resin foam.

### Example 3

A side wall was produced in the same manner as that of Example 2, except that a laminate (thickness of 16.0 mm) of the two silica aerogel-containing non-woven fabrics was used instead of the one silica aerogel-containing non-woven fabric.

### Example 4

A side wall was produced by laminating a corrugated plastic board (polypropylene sheet, thickness of 2.5 mm, manufactured by UBE EXSYMO CO., LTD., “E-2.5-55-BK”) on the one-side surface of the side wall of Example 2 via an acrylic double-coated pressure-sensitive adhesive tape (thickness of 0.17 mm, manufactured by NITTO DENKO CORPORATION, “TW-Y01”).

### Example 5

A side wall was produced in the same manner as that of Example 1, except that as a porous layer, one phenol resin foam (thermal conductivity of 0.024 W/(m·k), density of 34 kg/m³, closed cell ratio of 95%, thickness of 9.0 mm, manufactured by Asahi Kasei Corporation, “NEOMAFOAM 9-H6”), and as a protective layer, two polyethylene terephthalate non-woven fabrics lined with a polypropylene film (basis weight of 105 g/m², thickness of 1.0 mm, manufactured by Maeda Kosen Co., Ltd.) were prepared. The protective layer was disposed on the porous layer so that the napping portion of the non-woven fabric was positioned at the outside (the opposite side to the porous layer).

### Example 6

A side wall was produced in the same manner as that of Example 5, except that the protective layer (manufactured by Maeda Kosen Co., Ltd.) having the thickness of the napping portion described in Table 2 was used.

### Example 7

A side wall was produced in the same manner as that of Example 5, except that the protective layer (manufactured by Maeda Kosen Co., Ltd.) having the thickness of the napping portion described in Table 2 was used.

### Example 8

A side wall was produced in the same manner as that of Example 5, except that as a protective layer, a polyester and rayon composite non-woven fabric (basis weight of 115 g/m², thickness of 1.5 mm, manufactured by HOF, “ZETAFELT G9/4201/100 K81”) obtained by sintering a mixture of a thermoplastic resin and a thermosetting resin was used.

### Example 9

A side wall was produced in the same manner as that of Example 5, except that the thickness of the napping portion was changed to that described in Table 2 by hot pressing.

### Example 10

A side wall was produced in the same manner as that of Example 5, except that as a protective layer, a polyester non-woven fabric (the same as the description above) impregnated with the resorcin was used.

### Comparative Example 1

As a porous layer, one polyurethane resin foam (thermal conductivity of 0.039 W/(m·k), thickness of 15.0 mm, manufactured by INOAC CORPORATION, “ESR”), and as a protective layer, two polyester non-woven fabrics (the same as the description above) impregnated with the resorcin were prepared. A powdery hot melt adhesive was dottedly attached to the one-side surface and the other-side surface in the thickness direction of the porous layer, and the protective layer was laminated thereon to be then subjected to thermocompression bonding so that the total thickness of the side wall was 10.8 mm. The thickness of the porous layer after the thermocompression bonding was 9.0 mm. In this manner, a side wall of Comparative Example 1 was produced.

### Comparative Example 2

A corrugated plastic board (polypropylene sheet, thickness of 2.5 mm, manufactured by UBE EXSYMO CO., LTD., “E-2.5-55-BK”) was defined as a side wall.

### Comparative Example 3

Two corrugated plastic boards (the same as the description above) were laminated via the acrylic double-coated pressure-sensitive adhesive tape (the same as the description above), so that a side wall was produced.

(Measurement of Thermal Conductivity)

The thermal conductivity of each of the porous layers was measured at room temperature (23° C.) by using a quick thermal conducting meter (manufactured by KYOTO ELECTRONICS MANUFACTURING CO., LTD., “QTM-500”, current value of 0.25 A).

(Measurement of Thickness of Napping Portion)

The protective layers of the side walls of Examples 5 to 10 were disposed so as to face upwardly, and laser was applied thereto from the upper side, so that the thickness of the napping portion was measured. To be specific, the laser was applied to the protective layer, so that the height of the unevenness on the surface of the protective layer was measured, so that a graph (histogram) showing the height and the frequency was produced. Subsequently, in the histogram, the entire average value (average height) Havg and the maximum measurement value (the maximum height) Hmax were obtained, and a difference between the entire average value and the maximum measurement value was calculated as a thickness H of the napping portion (reference example was shown in FIG. 6). The results are shown in Table 2.

The measurement conditions were as follows.

Device: 3D measurement laser microscope, manufactured by Olympus Corporation, “LEXT OLS4100”

Objective lens: “MPLFLN10X”

Observation magnification: 10

Image size: 1024×1024 pixel

Photographing method: high-speed mode

Photographing range in Z direction: 2 mm (objective lens was moved to upper side from a focal position on the surface of the sample in a laser observation mode, and the portion where the whole screen got dark was set as the upper limit)

Average piece of image: two

Laser strength: manual adjustment (70%)

Data processing: use of curved surface noise reduction filter, output of the entire image data (1024×1024=1048576) with CSV file

(Heat Insulating Properties Test 1)

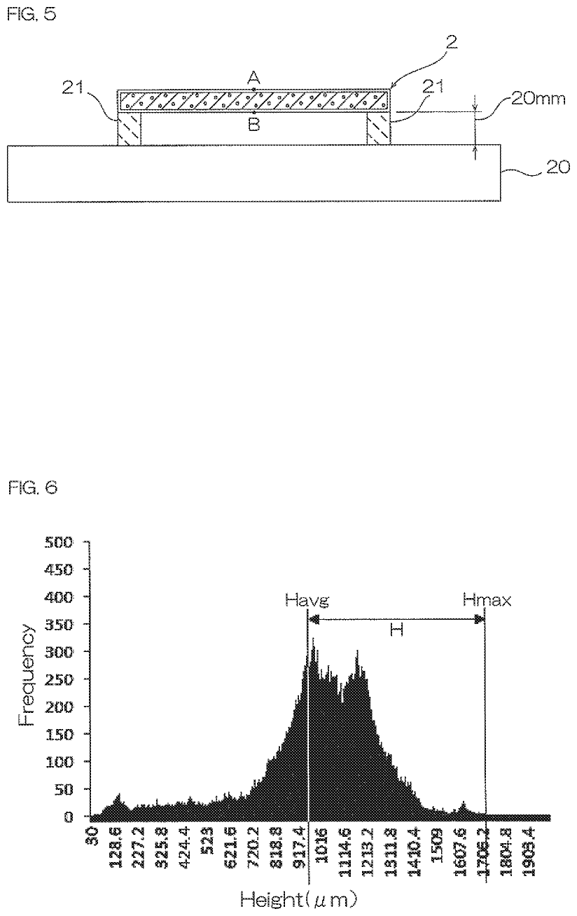

With respect to the side walls of Examples 1 to 4, and Comparative Examples 1 to 3, a wood-framed spacer 21 (thickness of 20 mm) having a rectangular frame shape in planar view was disposed on a heat source heater 20 that was heated at 95° C., and furthermore, each of the side walls 2 of Examples and Comparative Examples was disposed on the spacer 21 (ref: FIG. 5). In 60 minutes after the placement, the temperature of the central portion (A point; central portion of the surface that was the opposite side to the side of the heat source heater) on the upper surface of the side wall was measured. In Example 4, the side wall was disposed so that the side of the corrugated plastic board was at the lower side (side of the heat source). The results are shown in Table 1.

TABLE 1

| | Ex. 1 | Ex. 2 | Ex. 3 | Ex. 4 | Comp. Ex. 1 | Comp. Ex. 2 | Comp. Ex. 3 |
|---|---|---|---|---|---|---|---|
| Material | Phenol resin | Silica | Silica | Silica | Polyurethane | Corrugated | Corrugated |
| | Foam | Aerogel- | Aerogel- | Aerogel- | Foam | Plastic | Plastic |
| | | Impregnated | Impregnated | Impregnated | | Board | Board |
| | | Non-Woven | Non-Woven | Non-Woven | | | |
| | | Fabric | Fabric | Fabric | | | |
| Thickness (mm) | 7.0 | 8.0 | 16.0 | 8.0 | 9.0 | 2.5 | 5.0 |
| | 9.0 | 10.0 | 18.0 | 12.7 | 10.8 | 2.5 | 5.2 |
| ° C.) | 38.8 | 48.9 | 45.4 | 47.8 | 52.5 | 55.7 | 56.1 |

(Heat Insulating Properties Test 2)

With respect to the side walls of Examples 5 to 10, the wood-framed spacer 21 (thickness of 20 mm) having a rectangular frame shape in planar view was disposed on the heat source heater 20 that was heated at 95° C., and furthermore, each of the side walls 2 of Examples and Comparative Examples was disposed on the spacer 21 (ref: FIG. 5). From immediately after the placement (0 minute) to 60 minutes after the placement, the temperature difference between the central portion (A point; central portion of the surface that was the opposite side to the side of the heat source heater) on the upper surface of the side wall and the central portion (B point; central portion of the surface that was the side of the heat source heater) on the lower surface of the side wall was measured every minute. Subsequently, the total value of the temperature difference was calculated. The results are shown in Table 2.

TABLE 2

| | Ex. 5 | Ex. 6 | Ex. 7 | Ex. 8 | Ex. 9 | Ex. 10 |
|---|---|---|---|---|---|---|
| Thickness of | 541.0 | 657.5 | 453.2 | 431.3 | 98.3 | 179.8 |
| Napping | | | | | | |
| Portion (μm) | | | | | | |
| Total Value of | 1959.6 | 1885.7 | 1716.6 | 1739.1 | 1679.7 | 1679.0 |
| Temperature | | | | | | |
| Difference | | | | | | |
| (° C.) | | | | | | |

As clear in Table 2, when the thickness of the napping portion is particularly 400 μm or more (especially, 500 μm or more), the temperature difference between the upper surface and the lower surface of the side wall is furthermore significantly increased, so that it was found that the heat insulating properties were furthermore notably excellent.

While the illustrative embodiments of the present invention are provided in the above description, such is for illustrative purpose only and it is not to be construed as limiting the scope of the present invention. Modification and variation of the present invention that will be obvious to those skilled in the art is to be covered by the following claims.

### INDUSTRIAL APPLICABILITY

The battery cover of the present invention can be applied for various industrial products, and for example, can be preferably used for a cover of a secondary cell to be mounted on a vehicle, a ship, or the like.

### DESCRIPTION OF REFERENCE NUMERALS

1 Battery cover
2 Side wall
7 Porous layer
8 Protective layer
9 Napping portion
10 Battery

1. A battery cover comprising:
a side wall surrounding a battery, wherein
the side wall includes a porous layer, and a protective layer disposed at one side and the other side in a thickness direction of the porous layer, and
the thermal conductivity of the porous layer is 0.033 W/(m·K) or less.

2. The battery cover according to claim 1, wherein
the protective layer has a napping portion disposed to face to the battery, and
the napping portion has a thickness of 400 μm or more.

3. The battery cover according to claim 1, wherein
the porous layer is a phenol resin foam or a silica aerogel-containing non-woven fabric.

4. The battery cover according to claim 1, wherein
the porous layer has a thickness of 15.0 mm or less.
